(19) United States
(12) Patent Application Publication
(10) Pub. No.: US 2002/0177641 A1
(43) Pub. Date: Nov. 28, 2002

(54) Rubber composition and method of manufacturing the same

(76) Inventors: Naofumi Ezawa, Tokyo (JP); Hideki Komatsu, Tokyo (JP)

Correspondence Address: Sughrue Mion Zinn Macpeak & Seas PLLC, 2100 Pennsylvania Avenue N W, Washington, DC, 20037-3213, US

(21) Appl. No.: 09/517,696

(22) Filed: Mar. 2, 2000

(30) Foreign Application Priority Data
Mar. 3, 1999 (JP) 11-055555

(51) Int. Cl. C08K 3/34; C08K 3/00

(52) U.S. Cl. 524/191; 524/492

(57) ABSTRACT

This invention relates to a rubber composition and a method of manufacturing the same, and particularly to a technique of improving a fracture resistance in a silica-containing rubber composition by improving dispersion of the silica.

### BACKGROUND OF THE INVENTION

1. Field of the Invention

This invention relates to a rubber composition and a method of manufacturing the same, and particularly to a technique of improving a fracture resistance in a silica-containing rubber composition by improving dispersion of the silica.

2. Description of Related Art

Recently, articles in which environmental problems are considered are required, and there are, as properties required in a tire, a low rolling resistance and a durability which contribute to an energy saving and further a high braking property for obtaining safety. In order to satisfy these required properties, a silica-containing rubber composition has been used in a tire tread.

### SUMMARY OF THE INVENTION

A silica-containing rubber composition has the advantages mentioned above, and at the same time the silica-containing rubber composition also has a disadvantage of deteriorating a fracture resistance which affects a wear resistance. On the other hand, a workability also decreases since the unvulcanized rubber becomes high in viscosity owing to an aggregation of silica. In order to solve the above problems, various dispersing modifiers have been developed. However, any modifiers bring about the improved workability and a lower modulus.

It is, therefore, an object of the present invention to provide a rubber composition excellent in the fracture resistance by efficiently solving the disadvantages while maintaining the advantages.

According to the invention, there is the provision of a rubber composition comprising a rubber ingredient, not less than 20 parts by weight of silica based on 100 parts by weight of the rubber ingredient, and at least one of amide-group-containing compounds, a phenol resin and a resin-curing agent.

In a preferable embodiment of the present invention, the rubber composition further contains a silane coupling agent. In this case, the silane coupling agent is preferably compounded in an amount of 2-20% by weight based on the amount of the silica. Further, the amide group-containing compound is preferably compounded in an amount of 0.3-10 parts by weight based on 100 parts by weight of the rubber ingredient.

According to the invention, there is the provision of a method of manufacturing a rubber composition, in which the method comprises the step of compounding a rubber ingredient, silica, an amide-group-containing compound and a phenol resin added with a resin-curing agent. Further, there is the provision of a method of manufacturing a rubber composition, in which the method comprises the step of compounding a rubber ingredient, silica, an amide-group-containing compound, a phenol resin and a resin-curing agent.

### DESCRIPTION OF THE PREFERRED EMBODIMENTS

The rubber composition according to the present invention contains 100 parts by weight of rubber ingredient and silica of not less than 20 parts by weight. This is because it is necessary to contain silica of not less than 20 parts by weight for the purpose of having a low rolling resistance, a durability and a high braking property, and the object of the present invention is to improve the problems in such a rubber composition, namely the fracture resistance and the workability.

It is considered that since an amide-group has a strong interaction with a surface of silica, the amide-group-containing compound can be adsorbed onto the surface of the silica, as a result, aggregation of silica is controlled and dispersion of the silica is improved. And hence since aggregates of the silica is less, the workability can be improved because of decrease of the viscosity of the rubber composition.

However, as a result of improving the dispersion of the silica, the modulus of the rubber composition may decrease. This decreases a braking property. In this case, the modulus can be increased by compounding a resin and a resin-curing agent, but since by compounding the resin a rolling resistance is decreased, it is required that a small amount of the resin effectively reacts. The following amide-group-containing compounds can surprisingly promote a resinification reaction when compounded together with the resin containing the resin-curing agent, in addition to improvement of dispersion of silica. As a result, an intended modulus can be obtained by using a small amount of resin. That is, the present amide-group-containing compounds function not only as a dispersing modifier for silica but also as a promoter of the resinification reaction.

As the amide-group-containing compound compounded into the rubber composition of the present invention, mention may be made of formamide, acetamide, propionic acid amide, butyramide, capronamide, lauric acid amide, stearic acid amide, succinamide, urea, dimethylurea, benzamide, benzanilide, N-cyclohexylpropionic acid amide, N,N-di(hydroxyethylol)amide, ε-caprolactam, butyranilide, succinimide or the like. The acid residue is preferably an aliphatic compound. Because when aromatic ring is near to the amide group, it is difficult for the surface of the silica to adsorb the amide-group-containing compound onto its surface owing to steric hindrance. Among them, propionic acid amide and stearic acid amide are particularly preferable. The amide-group-containing compound can be used alone or in combination.

The amide-group-containing compound is preferably compounded in an amount of 0.3-10 parts by weight based on 100 parts by weight of the rubber ingredient. Because when it is less than 0.3 parts by weight, a sufficient compounding effect may not be obtained, while when it exceeds 10 parts by weight, the effect may not be sufficiently increased.

Further, in the present invention it is preferred that the silane coupling agent is further compounded. The compounding amount of the silane coupling agent is preferably 2-20% by weight based on the amount of silica. This is because when it is less than 2% by weight, a sufficient compounding effect may not be obtained, while when it exceeds 20% by weight, the wear resistance tends to lower.

Moreover, a phenol resin which is compounded to raise modulus of rubber composition. The phenol resin is preferably novolac resin. Concretely, mention may be made of a novolac type phenol resin which is derived from phenol, cresol or resorcin, a modified phenol resin which is produced by modifying the above-mentioned resin with an animal oil or a plant oil, such as rosin oil, tall oil, cashew oil, linseed oil or the like, with an unsaturated acid such as linoleic acid, oleic acid, linolenic acid or the like, with an aromatic hydrocarbon such as xylene, mesitylene or the like, or with a rubber such as nitrile rubber or the like. They can be used alone or in combination.

Its compounding amount is preferably 1-20 parts by weight based on 100 parts by weight of the rubber ingredient. Because when it is less than one part by weight, a sufficient compounding effect may not be developed, while when it exceeds 20 parts by weight, the properties of the rubber composition may decrease to form aggregates owing to bad dispersion of the resin into the rubber.

The phenol resin and the resin-curing agent may be compounded simultaneously, alternatively, the resin-curing agent may previously be added into the phenol resin. As examples of the resin-curing agent, mention may be made of hexamine, hexamethoxymethylmelamine or the like. Hexamethoxymethylmelamine is preferred.

The compounding amount of the resin-curing agent is preferably 1-50% by weight based on the amount of resin. This is because when it is less than 1% by weight, the effect may not be sufficient, while when it exceeds 50% by weight, the rate of vulcanization may become fast and workability may lower.

In the present invention, as the rubber ingredient at least one rubber selected from the group consisting of natural rubber and diene synthetic rubbers can be used appropriately. As the diene synthetic rubber mention may be made of butadiene rubber, styrene-butadiene rubber, isoprene rubber, butyl rubber, ethylene-propylene rubber or the like.

Besides, in the present invention, additives generally used can properly be compounded. As examples of the additives, mention may be made of carbon black, antioxidant, vulcanization accelerator, accelerator activator, softener and the like.

The rubber composition of the present invention can be manufactured through kneading and vulcanization of the compounded ingredients in the usual manner. The amide-group-containing compound may be compounded into the rubber after adsorbing onto silica or without adsorbing onto silica. In the latter case, it is preferred that the amide-group-containing compound and silica are simultaneously added.

The present invention will be explained on the basis of Examples and Comparative Examples below.

Various rubber compositions are prepared in the usual manner according to a compounding recipe as shown in Tables 1 and 2. And a fracture resistance, a viscosity of the unvulcanized rubber composition, a dynamic modulus (G′) and a hysteresis loss (tan δ). are measured about each of the rubber compositions. The results in Examples 1 and 2 and Comparative Examples 2-4 are represented by an index on the basis that Comparative Example 1 is 100, and the results in Examples 3 and 4 and Comparative Examples 6-8 are represented by an index on the basis that Comparative Example 5 is 100.

TABLE 1
(compounding unit: part by weight)

| | Com- | | | Com- | Com- | Com- |
|---|---|---|---|---|---|---|
| | para- | | | para- | para- | para- |
| | tive | | | tive | tive | tive |
| | Exam- | Exam- | Exam- | Exam- | Exam- | Exam- |
| | ple 1 | ple 1 | ple 2 | ple 2 | ple 3 | ple 4 |
| Rubber | | | | | | |
| ingredient | | | | | | |
| SBR #1500 | 80 | 80 | 80 | 80 | 80 | 80 |
| BR 01 | 20 | 20 | 20 | 20 | 20 | 20 |
| Carbon black | 10 | 10 | 10 | 10 | 10 | 10 |
| (N234) | | | | | | |
| Silica | 60 | 60 | 60 | 60 | 60 | 60 |
| Stearic acid | 2 | 2 | 2 | 2 | 2 | 2 |
| Antioxidant 6C | 1 | 1 | 1 | 1 | 1 | 1 |
| Si69 | 6 | 6 | 6 | 6 | 6 | 6 |
| Accelerator | | | | | | |
| activator | | | | | | |
| Zinc oxide | 3 | 3 | 3 | 3 | 3 | 3 |
| Vulcanization | | | | | | |
| accelerator | | | | | | |
| DPG | 0.9 | 0.9 | 0.9 | 0.9 | 0.9 | 0.9 |
| NS | 0.8 | 0.8 | 0.8 | 0.8 | 0.8 | 0.8 |
| DM | 0.6 | 0.6 | 0.6 | 0.6 | 0.6 | 0.6 |
| Sulfur | 1 | 1 | 1 | 1 | 1 | 1 |
| Stearic acid | — | 0.75 | — | — | 0.75 | — |
| amide | | | | | | |
| Propionic acid | — | — | 1 | — | — | 1 |
| amide | | | | | | |
| Phenol resin | — | 3 | 3 | 3 | — | — |
| HMMM | — | 2.25 | 2.25 | 2.25 | — | — |
| Viscosity of | 100 | 85 | 87 | 101 | 86 | 88 |
| unvulcanized | | | | | | |
| rubber | | | | | | |
| Fracture | 100 | 110 | 110 | 103 | 95 | 95 |
| resistance | | | | | | |
| Dynamic | 100 | 115 | 113 | 108 | 90 | 90 |
| modulus (G′) | | | | | | |
| Hysteresis | 100 | 92 | 93 | 102 | 91 | 92 |
| loss (tan δ) | | | | | | |

TABLE 2
(compounding unit: part by weight)

| | Com- | | | Com- | Com- | Com- |
|---|---|---|---|---|---|---|
| | para- | | | para- | para- | para- |
| | tive | | | tive | tive | tive |
| | Exam- | Exam- | Exam- | Exam- | Exam- | Exam- |
| | ple 5 | ple 3 | ple 4 | ple 6 | ple 7 | ple 8 |
| Rubber | | | | | | |
| ingredient | | | | | | |
| SBR #1500 | 80 | 80 | 80 | 80 | 80 | 80 |
| BR 01 | 20 | 20 | 20 | 20 | 20 | 20 |
| Carbon black | 35 | 35 | 35 | 35 | 35 | 35 |
| (N234) | | | | | | |
| Silica | 35 | 35 | 35 | 35 | 35 | 35 |
| Stearic acid | 2 | 2 | 2 | 2 | 2 | 2 |
| Antioxidant 6C | 1 | 1 | 1 | 1 | 1 | 1 |
| Si69 | 3.5 | 3.5 | 3.5 | 3.5 | 3.5 | 3.5 |
| Accelerator | | | | | | |
| activator | | | | | | |
| zinc oxide | 3 | 3 | 3 | 3 | 3 | 3 |
| Vulcanization | | | | | | |
| accelerator | | | | | | |
| DPG | 0.6 | 0.6 | 0.6 | 0.6 | 0.6 | 0.6 |
| NS | 0.8 | 0.8 | 0.8 | 0.8 | 0.8 | 0.8 |
| DM | 0.6 | 0.6 | 0.6 | 0.6 | 0.6 | 0.6 |
| Sulfur | 1 | 1 | 1 | 1 | 1 | 1 |
| Stearic acid | — | 0.75 | — | — | 0.75 | — |
| amide | | | | | | |
| Propionic acid | — | — | 1 | — | — | 1 |
| amide | | | | | | |
| Phenol resin | — | 3 | 3 | 3 | — | — |
| HMMM | — | 2.25 | 2.25 | 2.25 | — | — |
| Viscosity of | 100 | 92 | 93 | 100 | 92 | 94 |
| unvulcanized | | | | | | |
| rubber | | | | | | |
| Fracture | 100 | 106 | 106 | 101 | 98 | 97 |
| resistance | | | | | | |
| Dynamic | 100 | 120 | 119 | 112 | 95 | 95 |
| modulus (G′) | | | | | | |
| Hysteresis | 100 | 94 | 95 | 101 | 93 | 95 |
| loss (tan δ) | | | | | | |

SBR#1500 (trade name): emulsion polymerized styrene-butadiene copolymer rubber made by JSR Co.

BR01 (trade name): butadiene rubber made by JSR Co.

Carbon black (N234): Seast 7H (trade name) made by TOKAI CARBON CO., LTD.

Silica: Nipsil AQ (trade name) made by NIPPON SILICA Co., Ltd.

6C: N-(1,3-dimethylbutyl)-N′-phenyl-p-phenylenediamine

Si69 (trade name): made by Degussa AG Co., Ltd.

bis(3-triethoxysilylpropyl)tetrasulfide

DPG: diphenylguanidine

NS: N-tert-butyl-2-benzothiazylsulfenamide

DM: dibenzothiazyldisulfide

Phenol resin: R-PR50235 (trade name) made by Sumitomo DUREZ Co., Ltd.

HMMM: Cyrez 964 (trade name), resin-curing agent made by American Cyanamide Co.

Stearic acid amide: CH₃(CH₂)₁₆CONH₂ made by Tokyo Kasei Kogyo Co.,. Ltd.

Propionic acid amide: CH₃CH₂CONH₂ made by Tokyo Kasei Kogyo Co., Ltd.

Fracture Resistance

A test piece of a dumbbell shape pattern No. 3 in JIS K 6301-1995 is prepared with each rubber composition. The test piece is pulled at both ends and energy required before breaking is measured. The value is transformed to the index as mentioned above. The larger the index, the better the fracture resistance.

Dynamic Modulus (G′) and Hysteresis Loss (Tan δ)

This is measured at a temperature of 50° C., a strain of 2%, and a frequency of 15 Hz by using a viscoelasticity measuring device made of Rheometrics Co., Ltd. Each result is represented by an index. The larger the index, the better the dynamic modulus, and the smaller the index, the better the hysteresis loss.

Viscosity (ML₁₊₄ (125° C.))of Unvulcanized Rubber

This is conducted according to ASTM-1646. The smaller the index, the better the viscosity.

According to the present invention, the fracture resistance of the rubber composition compounded with silica can be improves, and the rubber composition of the present invention can be used for a tread rubber of a tire preferably.

What is claimed is:

1. A rubber composition comprising a rubber ingredient and not less than 20 parts by weight of silica based on 100 parts by weight of the rubber ingredient, which further contains at least one of amide-group-containing compound, a phenol resin and a resin-curing agent.

2. A rubber composition according to claim 1, wherein the phenol resin is novolac resin.

3. A rubber composition according to claim 1, wherein the phenol resin is phenol resin previously added with the resin-curing agent.

4. A rubber composition according to claim 1, wherein the rubber composition further contains a silane coupling agent.

5. A rubber composition according to claim 4, wherein the silane coupling agent is compounded in an amount of 2-20% by weight based on the amount of the silica.

6. A rubber composition according to claim 1, wherein the amide-group-containing compound is compounded in an amount of 0.3-10 parts by weight based on 100 parts by weight of the rubber ingredient.

7. A method of manufacturing a rubber composition, in which the method comprises the step of compounding a rubber ingredient, silica, an amide-group-containing compound and a phenol resin added with a resin-curing agent.

8. A method of manufacturing a rubber composition, in which the method comprises the step of compounding a rubber ingredient, silica, an amide-group-containing compound, a phenol resin and a resin-curing agent.
